(19) United States
(12) Patent Application Publication
(10) Pub. No.: US 2023/0067629 A1
(43) Pub. Date: Mar. 2, 2023

(54) CRYPTOGRAPHIC TECHNIQUES FOR UPDATING A DISTRIBUTED DATA STRUCTURE

(71) Applicant: Haste, Inc., Hermosa Beach, CA (US)

(72) Inventors: Daniel R. Wagner, Manhattan Beach, CA (US); Joseph S. DePinto, Manhattan Beach, CA (US); Eric LaForce, Charlotte, NC (US); Keith D. LaForce, Charlotte, NC (US)

(21) Appl. No.: 17/871,741

(22) Filed: Jul. 22, 2022

Related U.S. Application Data
(60) Provisional application No. 63/240,153, filed on Sep. 2, 2021.

(51) Int. Cl. H04L 9/00; H04L 9/08

(52) U.S. Cl. CPC H04L 9/50; H04L 9/0816

(57) ABSTRACT

Systems, methods, and techniques to update a distributed data structure. In one example, a service provider provides a computer-implemented service accessible to users, in which, upon use of the service by a user, the service provider broadcasts an entry to a distributed data structure of behalf of the user to a network that manages the distributed data structure such that the user can use the service. The entry can relate to various entities associated with the service, such as other users of the service.

### CLAIM OF PRIORITY

This application claims the benefit of U.S. Provisional Application No. 63/240,153, entitled “CRYPTOGRAPHIC TECHNIQUES FOR UPDATING A DISTRIBUTED DATA STRUCTURE,” filed Sep. 2, 2021, the entire contents of which is incorporated herein by reference.

### BRIEF DESCRIPTION OF THE DRAWING(S)

FIG. 1 illustrates an environment in which distributed data structure-based techniques can be used for service provider services, according to at least one embodiment;

FIG. 2 illustrates an example of an entry to be recorded in a distributed data structure, according to at least one embodiment;

FIG. 3 illustrates a swim diagram relating to a service provider and a distributed data structure, according to at least one embodiment;

FIG. 4 illustrates an example of a process for a service provider using a distributed ledger in connection with a service, according to at least one embodiment; and

FIG. 5 is an illustrative, simplified block diagram of a computing device that can be used to practice at least one embodiment of the present disclosure.

### DETAILED DESCRIPTION

Techniques and systems described herein relate to providing distributed data structure-based techniques for service provider services. In one embodiment, a service provider provides various services accessible to one or more users. The one or more users may interact with the various services. The one or more users may each be associated with one or more values. The service provider can maintain a ranking of entities for each service that indicates a ranking of one or more users based on uses of the service. The one or more users can be associated with the service provider such that the service provider may record entries on behalf of the one or more users in a distributed data structure, also referred to as a distributed ledger. An entry may be broadcast to a network of computing devices that maintains the distributed data structure, which may refer to a decentralized, distributed ledger that is used to immutably record various entries.

A service of the service provider computer system (e.g., a service with which interactions can be performed programmatically) can be associated with a minimum value to be included in one or more fields of an entry to be recorded on the distributed ledger. Upon use of the service by a user, the service provider may obtain a ranking of entities for the service. The service provider can record an entry on the distributed ledger, in which the entry may indicate the minimum value, and associations of portions of the minimum value to one or more users indicated in the ranking of entities. The user can access the service and perform various actions in connection with the service. The service provider can process the ranking of entities based on the access to the service by the user. The service provider can then record another entry on behalf of the user which encodes the ranking of entities on the distributed ledger.

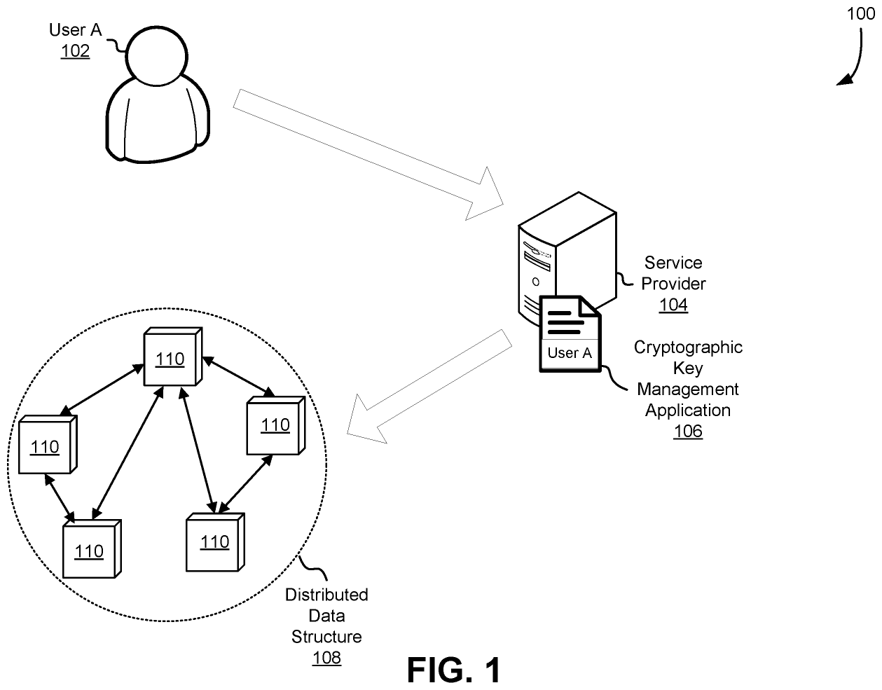

The service provider can configure and record an entry, such as those described herein, such that the entry satisfies sufficient conditions to be recorded on the distributed data structure. Associations indicated by the entry may occur by verification of the entry by a sufficient number of computer systems that participate in updates to the distributed data structure. Satisfaction of the conditions can include there being a sufficient number of entries already recorded on the distributed data structure usable as input to the entry to cause the already-recorded entries to become unusable for future entries once the entry is recorded. Further information regarding the distributed data structure can be found in description of FIG. 1.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

Techniques described herein may achieve various technical advantages, including but not limited to: an ability to efficiently associate values from an entity using a service to one or more entities based on a ranking of entities of the service; an ability to utilize a distributed data structure to securely encode information of one or more services; and various other technical advantages.

FIG. 1 illustrates an environment 100 in which distributed data structure-based techniques can be used for service provider services, according to at least one embodiment. An environment 100 may include a user A 102 that interacts with a service provider 104, in which the service provider 104, in connection with a cryptographic key management application 106, may perform various actions in connection with a distributed data structure 108 associated with nodes 110. It should be noted that an environment 100 may include various other entities not depicted in FIG. 1.

A user A 102, also referred to as a client, entity, and/or variations thereof, may refer to a user of services provided by a service provider 104. A user A 102 may have access to a computing device that has access to communication networks such as the Internet which can be used to communicate with entities, such as a service provider 104, in a remote manner. A user A 102 may perform various processes such as those described herein using one or more computing devices, such as a computer, tablet, mobile device (e.g., mobile phone), laptop, and/or variations thereof. In some embodiments, a user A 102 is associated with or otherwise has access to an account of multiple accounts managed by a service provider 104.

A service provider 104 may be an entity that provides one or more services to users individually and/or as a combination of services. A service may refer to one or more functions, operations, and/or processes accessible to one or more users. A service may be implemented using one or more hardware and/or software computing resources. In some examples, a service refers to an executing computer application that provides functionality to various entities. Services of a service provider 104 may be accessible to users via a network and may include services such as virtual computer system services, data storage services, cryptography services, notification services, security services, policy management services, task services, data processing services, applications, interfaces, and/or other such services. A service provider 104 may host one or more services provided by one or more other service providers. A service provider 104 may provide services that require user interaction.

In some examples, a service provider 104 provides a service to one or more users that can be associated with a ranking of users. A service provider 104 may host various software applications on behalf of various entities that may be associated with the software applications (e.g., gaming applications associated with gaming developers). For example, a service provider 104 hosts one or more interactive software applications, which can originate from one or more entities (e.g., developers of the software applications), in which users can interact with the one or more interactive software applications. Continuing with the example, for a particular interactive software application, the particular interactive software application is associated with a ranking of users based at least in part on user interactions with the interactive software application. A service provider 104 may provide a service that corresponds to one or more real-world events; the service may also be associated with a ranking based on the one or more real-world events. For example, a service provider 104 provides a service that corresponds to one or more real-world events that a user participates in, in which the service is associated with a ranking of users based on results of the one or more real-world events.

Users of a service provider 104 may communicate to the service provider 104 via an interface, which may be a web services interface or any other type of user interface. Each service provided by a service provider 104 may have its own interface, and subsets of the services may have corresponding individual interfaces in addition to, or as an alternative to, a common interface. A user may communicate with a service provider 104 through a network, whereby the network may be a communication network, such as the Internet, an intranet, an internet service provider (ISP) network and/or some other such network.

A user A 102 may access a service provided by a service provider 104. A user 102 may perform various authentication processes to access one or more services provided by a service provider 104. A service provider 104 may determine a ranking of users at a time of access to a service by a user A 102, in which the ranking of users may correspond to the service. A service provider 104 may implement a ranking of users for each service provided or otherwise hosted by the service provider 104. A ranking of users can be referred to as a ranking of entities, entity ranking, a leaderboard, and/or variations thereof. A ranking of users may be determined based on a previous access to a service by one or more users. In some examples, usage of a service by a user results in a score for the user, in which a ranking of users may be based on one or more scores for one or more users. A ranking of users may be specific to a service. For example, a service provider 104 provides or otherwise hosts a software application, in which one or more users interact with the software application; the service provider 104 may determine a ranking of users for the software application based on results of the interactions with the software application.

A ranking of users may be implemented using various data structures and/or data objects, such as an array, list, and/or variations thereof. A ranking of users may rank one or more users based at least in part on one or more values, such as scores, associated with the one or more users. A ranking of users may indicate a particular number of top ranked users. As an illustrative example, a plurality of users access a service, in which a ranking of users comprises a top ranked predefined number of users. In some embodiments, a service provider 104 creates and/or maintains a ranking of users based on one or more scores of one or more users, in which the ranking of users can be updated based on one or more new scores. As an illustrative example, a ranking of users indicates a first user with a first score in a first spot and a second user with a second score in a second spot, in which a third user uses the service and, as a result of usage of the service, obtains a third score that is greater than the second score, in which a service provider 104 updates the ranking of users to indicate the first user with the first score in the first spot and the third user with the third score in the second spot. A ranking of users may rank users in descending order, in which higher values (e.g., scores) correspond to higher ranked spots, ascending order, in which lower values correspond to higher ranked spots, or any suitable order. In some embodiments, a ranking of users is implemented using any suitable data object and/or data structure.

A user A 102 may have access to a cryptographic key management application 106. A cryptographic key management application 106 may be associated with a user A 102. In some examples, a cryptographic key management application 106 is a blockchain application. A cryptographic key management application 106 may be generated and/or maintained by one or more systems and/or services. In an embodiment, a service provider 104 generates and/or maintains a cryptographic key management application 106 for a user A 102. In at least one embodiment, a service provider 104 obtains or otherwise accesses a cryptographic key management application 106 for a user A 102 from one or more systems and/or services that may generate and/or maintain cryptographic key management applications. A cryptographic key management application 106 may refer to a collection of one or more hardware and/or software computing resources that encodes one or more cryptographic keys, such as one or more public keys and/or private keys. A cryptographic key management application 106 may include executable code that, when executed, performs various operations, such as cryptographic key generation operations, encryption operations, decryption operations, digital signature operations, and/or other cryptographic operations. A cryptographic key management application 106 may be a software program executing on computer hardware, application executing on computer hardware, software module, hardware device, and/or variations thereof.

A user A 102 may be associated with a value that corresponds to a cryptographic key management application 106 and/or the user A 102. A cryptographic key management application 106 may be associated with one or more interfaces of a service provider 104. In some examples, a service provider 104 generates or otherwise obtains one or more cryptographic keys for a cryptographic key management application 106 and associates the one or more cryptographic keys and/or the cryptographic key management application 106 to a user A 102. A user A 102 may generate or otherwise obtain one or more cryptographic keys for a cryptographic key management application 106 and provide the one or more cryptographic keys and/or the cryptographic key management application 106 to a service provider 104. A service provider 104 may record entries (e.g., in a distributed ledger) on behalf of a user A 102 using a cryptographic key management application 106. In this manner, a service provider 104 can record entries on behalf of a user A 102 (e.g., by using a cryptographic key management application 106) to one or more entities without requiring various action from the user A 102. Entries recorded by a service provider 104 may be based on a ranking of users which may include a user A 102.

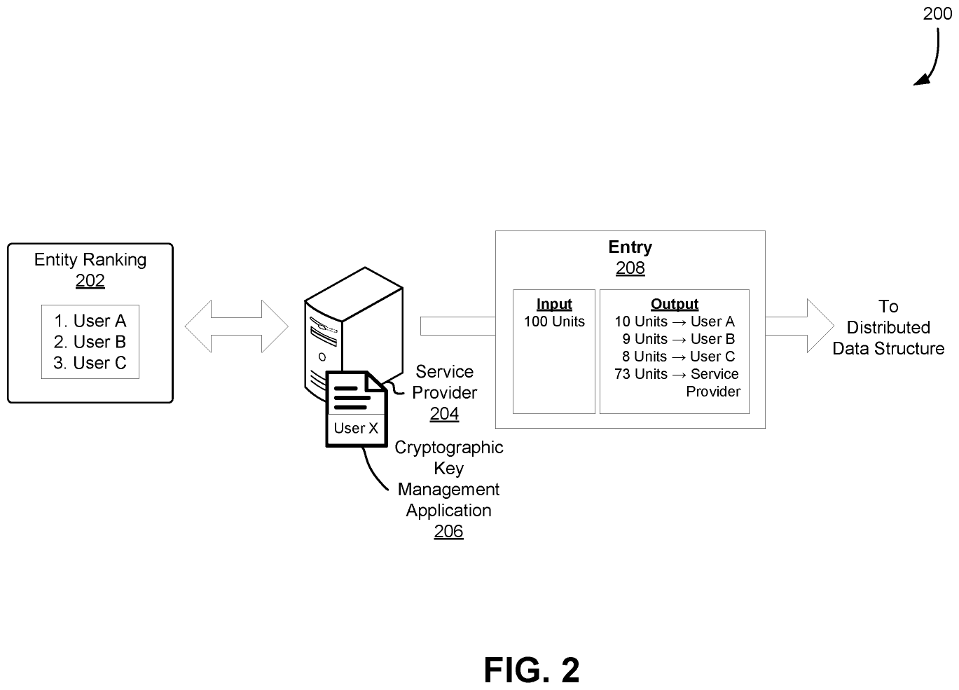

A service provider 104 may record one or more entries (e.g., in a distributed data structure 108) when a user A 102 accesses a service of a service provider 104. One or more entries may indicate associations of one or more values to one or more users based on a ranking of users. A service hosted or otherwise provided by a service provider 104 can be associated with a minimum value to be included in one or more fields (e.g., one or more fields of an output) of an entry to be recorded on a distributed data structure 108, in which a service provider 104 may record the entry indicating at least the minimum value in the one or more fields and one or more entities. The one or more fields may indicate one or more entities and one or more values that sum to the minimum value. A particular value of a particular field that indicates a particular user may be based on a rank of the particular user. For example, a first field indicates a first user that is ranked in a first position, in which the first field indicates a first value that is a particular percentage of the minimum value, and so on. Further information regarding an entry can be found in the description of FIG. 2.

When a user A 102 accesses a service, a service provider 104 may record an entry using a cryptographic key management application 106 indicating at least the minimum value (e.g., in one or more fields) and the one or more entities. A service provider 104 may utilize an entry to indicate the service provider 104. A service provider 104 may utilize an entry to indicate an entity associated with a service (e.g., a developer or service provider of the service). A service provider 104 may utilize one or more fields of an entry to indicate one or more users based on a ranking of the users. A rank of a user may determine a value that is a portion of the minimum value to be associated to the user.

A user A 102 may access a service hosted or otherwise provided by a service provider 104. Upon completion of use of a service by a user A 102, a service provider 104 may record another entry using a cryptographic key management application 106, which can encode results of the use of the service. A service provider 104 may utilize the other entry to encode a ranking of users for a service. A service provider 104 may record or otherwise encode an entry in a distributed data structure 108 by broadcasting the entry to the distributed data structure 108 via one or more networks, which may cause the entry to be encoded in the distributed data structure 108. In some examples, a service provider 104 records an entry that encodes a ranking of users for a service hosted or otherwise provided by the service provider 104, which may be updated after a user A 102 accesses the service. An entity associated with a service (e.g., a developer or service provider of the service) hosted or otherwise provided by a service provider 104 may perform various processes in connection with the service provider 104 to update a ranking of users for the service based on accesses to the service by one or more users.

In an embodiment, one or more systems record one or more entries in connection with a distributed data structure 108. A distributed data structure may refer to a decentralized, distributed ledger that is used to immutably record entries, also referred to as transactions. A distributed ledger may be implemented by a blockchain network. A distributed ledger implemented by a blockchain network may be referred to as a distributed data structure, or more generally as a blockchain. In various examples, a blockchain network refers to a network of one or more devices each running an instance of a blockchain protocol. A blockchain network may comprise peer-to-peer distributed electronic devices each running an instance of a blockchain protocol. In various embodiments, distributed devices part of a blockchain network are referred to as nodes. In an embodiment, a blockchain protocol is a collection of one or more hardware and/or software resources with instructions that, when executed, facilitates various blockchain operations. A blockchain protocol may be any suitable protocol, such as Bitcoin, Ethereum, Ripple Consensus Network, Hyperledger, R3's Corda, Symbiont Distributed ledger, and the like. In an embodiment, a blockchain protocol is a Bitcoin Satoshi Vision (BSV) protocol.

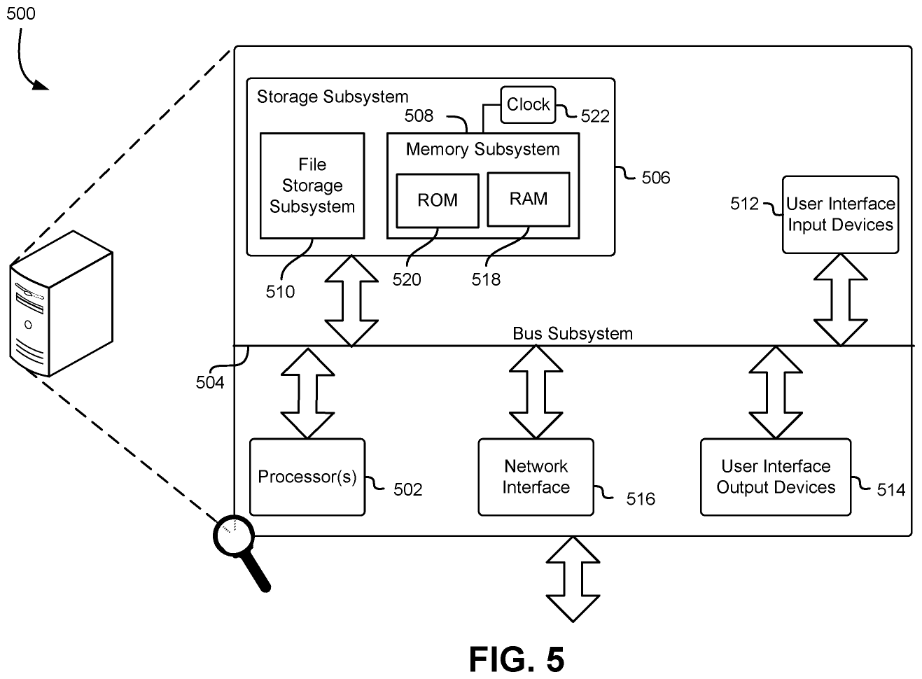

A blockchain network may include nodes 110, which may comprise one or more nodes. A node may be any suitable computing device and/or devices, such as a server computing device, a client computing device (e.g., a desktop computer, laptop computer, tablet computer, mobile device, and/or variations thereof), a computing device in a distributed system, multiple computing devices in a distributed system, or any suitable computing device such as a computing device 500 of FIG. 5. Nodes 110 may include nodes that may be implemented on computing resources owned, accessible, and/or otherwise under the control of a particular party. Nodes 110 may include nodes with access to one or more networks, such as the Internet, to perform various cryptographic and blockchain related functions. In an embodiment, nodes 110 include one or more nodes that each run or otherwise execute an instance of a blockchain protocol.

In at least one embodiment, one or more nodes of nodes 110 are communicatively coupled to one or more nodes of the nodes 110. In some examples, communicatively coupling can include wired communication, wireless communication, and/or variations thereof. One or more nodes of nodes 110 each may maintain at least a portion of a distributed ledger of all entries in a blockchain. A distributed ledger may be distributed in the sense that each of one or more nodes of nodes 110 may maintain at least a portion of the distributed ledger. In some examples, each of one or more nodes of nodes 110 maintains an entire distributed ledger, or any suitable portion of a distributed ledger. In an embodiment, an entry processed by a node that affects a distributed ledger is verifiable by one or more of other nodes such that the integrity of the distributed ledger is maintained.

One or more nodes of nodes 110 may be nodes that are referred to as miner nodes. Miner nodes may perform various complex calculations, such as solving one or more cryptographic problems. A miner node that solves a cryptographic problem may generate a new block for a blockchain and broadcast the block to other nodes, in which the other nodes may verify the work of the miner node and, upon verification, accept the block into the blockchain (e.g., by adding it to a distributed ledger of the blockchain). In an embodiment, a block comprises a group of entries, and may comprise a timestamp and a cryptographic hash of a previous block. Each block may be linked to a previous block (e.g., via a cryptographic hash), resulting in a “chain” that links blocks in a blockchain. In some embodiments, valid blocks are added to a blockchain by a consensus of nodes 110. A blockchain may comprise a list of validated blocks.

One or more of nodes 110 may be nodes that are referred to as validating nodes. A node of nodes 110 may be a miner node, validating node, and/or variations thereof. A validating node may validate entries. In some embodiments, an entry, also referred to generally as data, indicates one or more values that are to be associated to or with one or more entities. An entry may include data that provides proof of possession of a value and conditions for accepting or transferring possession/control of one or more values which may be portions of the value. In some examples, a value indicated in an entry corresponds to a unit of cryptocurrency, such as Bitcoin (BTC), Ether (ETH), XRP, Cardano, Dogecoin, and/or variations thereof. A spending entry may refer to an entry that reassociates (e.g., transferring possession or control) at least a portion of a value, indicated by an unspent transaction output (UTXO) of a previous entry, to an entity associated with a blockchain address. A previous entry may refer to an entry that contains a UTXO being referenced by a spending entry. An entry may include a script or other executable code, which can be referred to as a locking script and/or variations thereof, which encumbers the entry with conditions that must be fulfilled before possession/control can be transferred, also referred to as unlocked. A locking script may be used in connection with another script or other executable code, which may be referred to as an unlocking script and/or variations thereof, that may satisfy various conditions of the locking script. In an embodiment, a blockchain address is a string of alphanumeric characters that is associated with an entity to which control of at least a portion of a value is being transferred/reassociated. There may be a one-to-one correspondence between a public key associated with an entity and a blockchain address. In some examples, validation of entries comprises validating one or more conditions specified in a locking script and/or unlocking script. Upon successful validation of an entry, a validation node may add the entry to a blockchain and distribute it to associated nodes (e.g., nodes 110).

An entry may indicate one or more inputs and/or one or more outputs. An input may indicate an output of a previous entry (e.g., UTXO). An input may indicate at least a portion of one or more values associated with one or more previous entries. An output may indicate one or more addresses associated with one or more entities to which control of at least a portion of one or more values (e.g., indicating by an input) is being transferred/reassociated, also referred to as associated. An input of an entry may indicate a particular value and an output of the entry may indicate an entity (e.g., through a blockchain address) and at least another value that is a portion of the particular value, in which the other value is to be associated to the entity as a result of the entry being recorded in a distributed ledger such as those described herein.

An output of an entry may indicate one or more entities and corresponding one or more values, which may sum to at least a portion of a particular value indicated in an input of the entry, in which the one or more values are to be associated with the one or more entities in connection with the entry. The output may comprise one or more fields, each utilized to indicate a particular entity and a particular value to be associated to the particular entity. A value may be associated with an entity, in which the entity may associate one or more portions of the value to one or more other entities via an entry. An association of a value from one entity to another entity can be referred to as a digital asset transfer. A system may record an entry in a distributed data structure indicating at least the association. The system may record the entry such that the entry satisfies sufficient conditions, such as those described herein, to be recorded on the distributed data structure. The association indicated by the entry may occur by verification of the entry by a sufficient number of computer systems (e.g., nodes 110) that participate in updates to the distributed data structure. Satisfaction of the conditions can include there being a sufficient amount of values indicated in one or more entries already recorded on the distributed data structure usable as an input to the entry such that a sum of one or more values indicated in an output of the entry is less than or equal to the amount of values, which may cause the already recorded entries to become unusable for future entries once the entry is recorded. In some examples, an entry comprises one or more digital signatures utilized for validation of the entry. An entity may, as part of creating an entry, generate a digital signature based at least in part on a cryptographic secret, such as a private key associated with the entity, and data of entry, and include the digital signature in the entry. An entry may be broadcast by one or more entities to nodes 110.

In an embodiment, an entity is associated with a cryptographic key management application which can be used for various types of exchanges. A cryptographic key management application, also referred to as a blockchain digital application, may be a collection of one or more hardware and/or software computing resources that encode cryptographic keys for various entries. A cryptographic key management application may encode one or more public keys, which may correspond to and/or be utilized to determine one or more blockchain addresses, and one or more private keys, which can be utilized for various entries. A cryptographic key management application may be associated with one or more blockchain addresses that are associated with control of various values, and can be utilized to associate control of various values (e.g., to one or more entities via blockchain addresses). In some examples, one or more systems record entries on behalf of users. One or more systems may implement or otherwise utilize various interfaces that enable the one or more systems to record entries on behalf of users. One or more systems may utilize various APIs that implement functionalities to record entries on behalf of users. In some examples, an entity utilizes a cryptographic key management application associated with one or more interfaces such that one or more systems may record entries in connection with the cryptographic key management application on behalf of the entity. Interfaces may include interfaces such as various software development kits, programming interfaces, and the like associated with various blockchain protocols.

A service provider may associate one or more values on behalf of a user to one or more entities (e.g., such as the user, or other users indicated by a ranking of users) via an entry in connection with a cryptographic key management application associated with the user. The service provider may obtain one or more outputs of one or more previous entries. The one or more outputs may be associated with one or more locking scripts, which may correspond to the user. The service provider may indicate the one or more outputs in an input of the entry.

The service provider may use a cryptographic key, such as a private key, from the cryptographic key management application to generate one or more digital signatures. The one or more digital signatures may be generated based on data of the entry, such as data of an input and/or output of the entry, which may be processed through one or more hash functions. The service provider may generate one or more unlocking scripts, that may encode the one or more digital signatures as well as one or more cryptographic keys, such as another cryptographic key (e.g., a public key) corresponding to the cryptographic key (e.g., a private key) used to generate the one or more digital signatures, of the cryptographic key management application. The one or more unlocking scripts may provide data that satisfies one or more conditions of the one or more locking scripts. As an illustrative example, a locking script may include a condition requiring validation of a digital signature of an unlocking script, in which, upon execution of the unlocking script and the locking script, the locking script may perform various processes (e.g., one or more signature verification algorithms) using a public key of the unlocking script to determine whether the digital signature is valid; if so, the condition may be satisfied.

The service provider may utilize one or more cryptographic keys of the cryptographic key management application to generate the one or more unlocking scripts such that the one or more unlocking scripts satisfy one or more conditions of the one or more locking scripts. The service provider may utilize one or more cryptographic keys of the cryptographic key management application to generate the entry such that the entry satisfies various conditions (e.g., an unlocking script of the entry satisfies conditions of a locking script of the entry) such that the entry can be validated and added to a distributed data structure.

The service provider may include data indicating the one or more entities and one or more values to be associated to the one or more entities as an output of the entry. The service provider may include one or more other locking scripts corresponding to the one or more entities in the output. The service provider may broadcast the entry to the distributed data structure, in which nodes associated with the distributed data structure may validate the entry by at least verifying that the one or more unlocking scripts satisfy the one or more conditions of the one or more locking scripts. The entry may be added or otherwise encoded in the distributed data structure. In some examples, the entry is only added to the distributed data structure if the one or more unlocking scripts satisfy the one or more conditions of the one or more locking scripts.

Use of a distributed data structure may result in various technical properties. Data stored on a distributed data structure may be immutable, which may refer to a property of data in which contents of the data may not be changed or otherwise altered without validation from nodes associated with the distributed data structure. Data on a distributed data structure may be publicly accessible or otherwise viewable. Use of a distributed data structure may provide a publicly provable record of authenticity of various data stored within the distributed data structure.

A service provider 104 may also issue one or more non-fungible tokens (NFTs) to one or more users. An NFT may refer to a unit of data stored within a distributed data structure 108. A service provider 104 can issue one or more NFTs through one or more entries which can encode the one or more NFTs within a distributed data structure 108. An NFT can be associated with information that indicates an entity corresponding to the NFT, and an entity using the NFT, which can be the same entities. In some embodiments, a service provider 104 issues an NFT to a user of the service provider 104, in which the NFT is associated with information that indicates that the user corresponds to the NFT, and the user is using the NFT. Use of an NFT can be exchanged amongst users. For example, an NFT is associated with information that indicates a first user is using the NFT, in which the first user exchanges use of the NFT to a second user, in which the information is updated to indicate that the second user is using the NFT.

An NFT can be utilized to associate one or more values to a user. Every time a first user accesses a service provided by a service provider 104, one or more values can be associated by the service provider 104 to a second user using an NFT that corresponds to the first user (e.g., the NFT is associated with information that the first user corresponds to the NFT and the second user is using the NFT), in which the first user and the second user can be the same or different user. The one or more values can be any suitable portion of a minimum value associated with a particular service. In an embodiment, a particular NFT is associated with information that indicates that a first user corresponds to the NFT, and a second user is using the NFT, in which every time the first user accesses a service, as part of an entry as a result of the first user accessing the service, one or more values are associated to the second user, which is any suitable portion.

A service provider 104 can issue tokens such as those described herein to users. A service provider 104 can provide fungible tokens to one or more users in various time intervals, such as daily, weekly, and/or variations thereof. A service provider 104 can provide a set number of tokens to all users of the service provider 104. A number of tokens provided per user can be based on one or more values associated to other entities in connection with the user in a previous time interval. In some examples, a ratio of a number of tokens provided to a user to a set number of tokens provided to all users is equivalent to a ratio of values associated to other entities in connection with the user in a previous time interval to total values associated to other entities in connection with all the users in the previous time interval.

A service provider 104 may implement one or more application programming interfaces (APIs). In an embodiment, an API is a set of subroutine definitions, communication protocols, and/or software tools that provide a method of communication between entities, such as an entity (e.g., a client or other service provider) and a service provider (e.g., a service provider 104). In some examples, various service providers communicate to a service provider 104 through API requests to access various services of the service provider 104. An entity associated with a service provided or otherwise hosted by a service provider 104, such as a developer of the service, can utilize various API requests to manage use of the service.

API requests may be web service API requests. In an embodiment, an API is a Representational state transfer (REST) API, or any suitable software architectural style, such as Simple Object Access Protocol (SOAP). Entities may utilize cryptographically protected communications sessions to communicate to a service provider 104. Entities may submit appropriately configured API requests to a service provider 104 through one or more web service interfaces. An API request may be considered to be appropriately configured if it is formatted sufficiently and contains information (e.g., authentication information such as a digital signature or other credential or information generated from a credential) sufficient to cause a receiving system to fulfill the request. Generally, it should be understood that unless explicitly contradicted or otherwise clear from context, the movement of data, and interactions, from one system to another can be performed in any suitable manner, such as in a single transmission, by streaming (e.g., by transmitting the data in pieces over multiple transmissions), or otherwise.

A service provider 104 may process and fulfill various API requests in connection with services provided or otherwise hosted by the service provider 104. A service provider 104 may define one or more structures of information for one or more API requests and/or responses using one or more models, schemas, and/or variations thereof. A service provider 104 may utilize various data objects in connection with one or more API requests and/or responses.

A service provider 104 may support various API requests that an entity can utilize to manage one or more services hosted or otherwise provided by the service provider 104, as well as one or more rankings of users associated with the one or more services. API requests can include requests to retrieve data of a service, create, update, and/or maintain a service, create, update, and/or maintain an announcement in connection with a service, create, update, and/or maintain an NFT in connection with one or more users, create, update, and/or maintain operation of a service, create, update, and/or maintain a ranking of users in connection with a service, and/or any suitable operation in connection with a user, a service, a ranking of users, a service provider 104, a cryptographic key management application 106, a distributed data structure 108, and/or variations thereof.

FIG. 2 illustrates an example 200 of an entry, according to at least one embodiment. An entity ranking 202, a service provider 204, a cryptographic key management application 206, and an entry 208 may be in accordance with those described herein. A service provider 204 may provide a service associated with an entity ranking 202. An entity ranking 202 may correspond to a service hosted or otherwise provided by a service provider 204. A service provider 204 may maintain an entity ranking 202 for a service through one or more data objects and/or data structures.

A user can access a service, in which a service provider 204 may obtain an entity ranking 202 corresponding to the service. An entity ranking 202 can indicate results of use of a service. For example, one or more users utilize a service previous to when a user is accessing the service, in which an entity ranking 202 is a ranking of the one or more users at a time when the user is accessing the service. Referring to FIG. 2, for example, an entity ranking 202 indicates a “User A” ranked in a first position, a “User B” ranked in a second position, and a “User C” ranking in a third position.

A service provider 204 may record various entries using a cryptographic key management application 206. A cryptographic key management application 206 may be associated with a user, denoted by “User X,” who may be a user who is accessing a service. A user, denoted by “User X,” may be associated with a value corresponding to a cryptographic key management application 206. A service provider 204 may broadcast an entry 208 using a cryptographic key management application 206 to a distributed data structure at a time when a user denoted by “User X” accesses a service. An entry 208 may associate one or more values from a cryptographic key management application 206 to one or more cryptographic key management applications of one or more entities. In this manner, a service provider 204 can associate one or more values on behalf of a user (e.g., by using a cryptographic key management application 206) to one or more entities.

A service provider 204 may broadcast an entry 208 based at least in part an entity ranking 202. An entry 208 may indicate associations of one or more values to one or more entities. An entry 208 may indicate inputs corresponding to one or more outputs of one or more previous entries. Referring to FIG. 2, for example, an entry 208 indicates an input of a value of 100 units. An entry 208 may indicate outputs to one or more entities. A service provider 204 may determine an output of an entry 208 based on an entity ranking 202. An output may indicate associations of one or more values to one or more entities, in which the associations can be made to one or more blockchain addresses associated with the one or more entities. In some embodiments, an output indicates associations of one or more values to one or more entities through one or more blockchain addresses associated with the one or more entities. A total value associated to one or more entities via an entry 208 (e.g., indicated through one or more fields of an output) can sum to a minimum value associated with a service (e.g., a minimum value to be included in one or more fields of an output of entry 208 to access or otherwise utilize the service).

As an illustrative example, referring to FIG. 2, the minimum value is 100 units. A service provider 204 may determine one or more fields of an output of an entry 208 based on an entity ranking 202. For example, a service provider 204 determines that a first entity in a first position is to be associated 10% of the minimum value, in which the service provider 204 generates a first field indicating the first entity and a value that is 10% of the minimum value, a second entity in a second position is to be associated 9% of the minimum value, in which the service provider 204 generates a second field indicating the second entity and a value that is 9% of the minimum value, and an entity in a third position is to be associated 8% of the minimum value, in which the service provider 208 generates a third field indicating the third entity and a value that is 8% of the minimum value. The remainder of the minimum value can be associated to any suitable entity, which may or may not be associated with the entity ranking 202, such as a service provider (e.g., service provider 204) or other suitable entity.

Referring to FIG. 2, for example, an entry 208 indicates associations of 10 units to a User A, 9 units to a User B, 8 units to a User C, and 73 units to a service provider; in various embodiments, an entity can be denoted by a blockchain address associated with the entity (e.g., “User A” can be replaced with a blockchain address associated with the “User A”). It should be noted that FIG. 2 is intended to be an illustrative example, and percentages of the minimum value can be any suitable percentages and can be associated to any suitable entities. As an illustrative example, an entry 208 can indicate an output indicating associations of 10 units to a User A, 9 units to a User B, 8 units to a User C, 10 units to an entity associated with a service provider, 63 units to a service provider, and/or any suitable amounts to any suitable entities. An association of a value to a user or other entity may be done to a cryptographic key management application associated with the user or other entity.

In an embodiment, use of a service by a user results in a value determined by the service for the user, also referred to as a score. A user may access a service and obtain a score that is utilized to update an entity ranking 202. For example, if a user accesses a service and obtains a score that is greater than a score indicated in an entity ranking 202, a service provider 204 updates the entity ranking 202 to indicate the user and the score for the user. A service provider 204 may update an entity ranking 202 following use of a service by a user. In various embodiments, a service provider 204 only updates an entity ranking 202 if a use of a service by a user results in a score that is greater than one or more scores indicated in the entity ranking 202. Following completion of a use of a service by a user, a service provider 204 may broadcast another entry that encodes an entity ranking 202, which may or may not be updated based on a score resulting from the use of the service by the user.

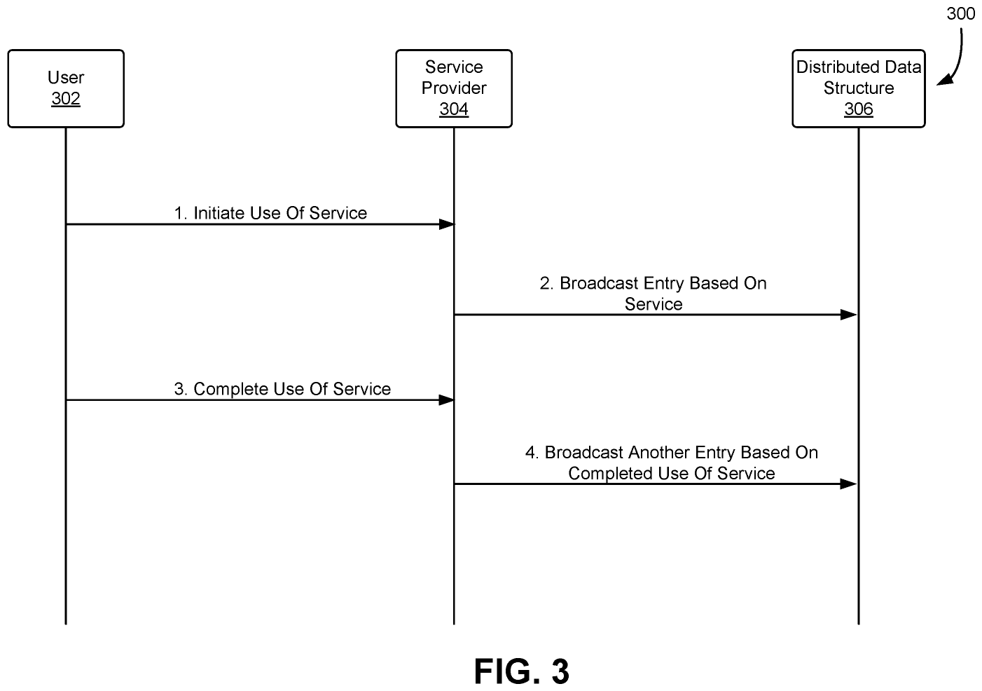

FIG. 3 illustrates a swim diagram 300 relating to a service provider and a distributed data structure, according to at least one embodiment. A user 302, a service provider 304, and a distributed data structure 306 may be in accordance with those described elsewhere in this disclosure. A service provider 304 may provide one or more services. A service provider 304 may host one or more services on behalf of one or more entities. Services may include a service such as an interactive software application, a service that corresponds to one or more real world events, and the like. In some embodiments, use of a service is associated with a minimum value to be included in total in one or more fields (e.g., one or more fields of an output) of an entry to be recorded on a distributed ledger, which may be required to access the service. A user may use a service, in which the service may provide a score for the user based on the use of the service. A service provider 304 may maintain a ranking of users for a service, which may comprise indications of one or more users ranked in an order based on one or more scores for the one or more users. A service provider 304 may maintain a ranking of users for a service through any suitable data object and/or data structure.

A user 302 may initiate use of a service. A user 302 may interact with one or more interfaces of a service provider 304 to initiate use of a service. One or more interfaces may include web interfaces, such as a website or other suitable interface. A service provider 304 may detect use of a service by a user 302, and obtain a ranking of users maintained by the service provider 304 for the service. A service provider 304 may broadcast an entry based on a service to a distributed data structure 306 upon use of the service by a user 302. An entry may associate one or more values to one or more entities, in which a total amount of the one or more values may sum to the minimum value. A service provider 304 may broadcast an entry on behalf of a user 302 in connection with a cryptographic key management application associated with the user 302.

A service provider 304 may broadcast an entry in which an output of the entry is based on a ranking of users of a service. In some examples, a total amount of values associated to one or more entities in an entry upon use of a service by a user sums to a required or minimum amount to access the service. A service provider 304 may associate one or more values to one or more users indicated in a ranking of users. A service provider 304 may associate one or more values to one or more entities associated with a service, such as a provider of the service, the service provider 304, other entities associated with the service provider 304, and the like. A service provider 304 may determine one or more percentages of a minimum value to access a service to associate to one or more users. A service provider 304 may associate a first amount of the minimum value to a first ranked user, a second amount of the minimum value to a second ranked user, and so on. A percentage associated to an entity can be any suitable percentage. A percentage of the minimum value associated to a user can be any suitable percentage based on a ranking of the user. As an illustrative example, a service provider 304 determines that a user in a first position is to be associated 10% of the minimum value, a user in a second position is to be associated 9% of the minimum value, a user in a third position is to be associated 8% of the minimum value, and so on.

A user 302 may access a service after a service provider 304 broadcasts an entry to a distributed data structure 306 upon initiation of use of the service by the user 302. In some examples, a service is an interactive application in which a user 302 interacts with the application to perform various actions. A user 302 may use a service in which, after use of the service, the service determines a score for the user 302 based on results of the use of the service. A user 302 may complete use of a service. A service may utilize various logic, heuristics, and/or rules that determine when use of a service by a user is complete. For example, a use of a service by a user is complete after the user has performed one or more actions in connection with the service to determine one or more results.

A score determined for a user in connection with a service can be utilized by a service provider 304 to update a ranking of users associated with the service. A service provider 304 can obtain a score for a user for a particular service and determine whether the score is greater than a minimum score of one or more scores for one or more users in a ranking of users for the service; if the score is greater than the minimum score of the one or more scores, the service provider 304 can update the ranking of users to indicate the user and the score, or if the score is less than and/or equal to the minimum score of the one or more scores, the service provider 304 can leave the ranking of users as is. A service provider 304 may then broadcast another entry based on a completed use of a service to a distributed data structure 306. A service provider 304 may broadcast an entry that encodes a ranking of users for a service after a user has accessed the service, in which the ranking of users may or may be not be updated based on a score determined by the service for the user.

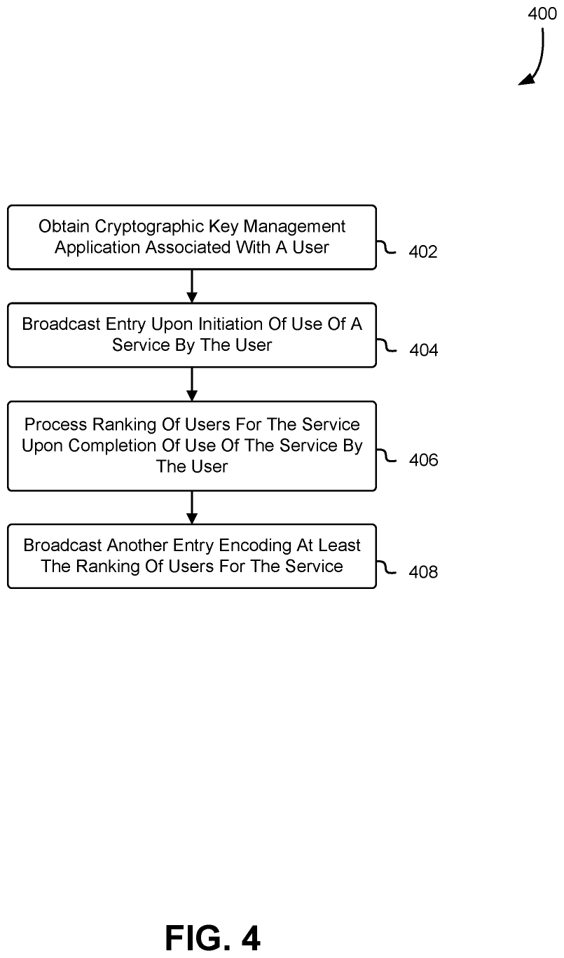

FIG. 4 illustrates an example of a process 400 for a service provider using a distributed ledger in connection with a service, according to at least one embodiment. In at least one embodiment, some or all of process 400 (or any other processes described herein, or variations and/or combinations thereof) is performed under control of one or more computer systems configured with computer-executable instructions and is implemented as code (e.g., computer-executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. In at least one embodiment, a computer-readable storage medium is a non-transitory computer-readable medium. In at least one embodiment, at least some computer-readable instructions usable to perform process 400 are not stored solely using transitory signals (e.g., a propagating transient electric or electromagnetic transmission). In at least one embodiment, a non-transitory computer-readable medium does not necessarily include non-transitory data storage circuitry (e.g., buffers, caches, and queues) within transceivers of transitory signals. In at least one embodiment, process 400 is performed at least in part on a computer system such as those described elsewhere in this disclosure. In an embodiment, process 400 is performed by a service provider such as those described in connection with FIGS. 1-3.

In at least one embodiment, a system performing at least a part of process 400 includes executable code to obtain 402 a cryptographic key management application associated with a user. The cryptographic key management application may be a blockchain application. The cryptographic key management application may be associated with one or more interfaces of the system. The cryptographic key management application may be generated and/or maintained by one or more systems and/or services, in which the system may obtain the cryptographic key management application from the one or more systems and/or services. The system may utilize the one or more interfaces to record one or more entries using the cryptographic key management application on behalf of the user.

In at least one embodiment, a system performing at least a part of process 400 includes executable code to broadcast 404 an entry upon initiation of use of a service by the user. The entry may indicate associations of one or more values to one or more entities, which may be indicated through one or more blockchain addresses associated with the one or more entities. The system may host or otherwise provide one or more services. The service may be an interactive application. The service may correspond to one or more real world events. The service may be associated with a minimum value to be included in total in one or more fields (e.g., one or more fields of an output) of an entry to be recorded on a distributed ledger. The service may be associated with a ranking of users maintained by the system for the service. In some embodiments, the service, upon being used by a user, calculates a score for the user. The ranking of users may indicate one or more scores of one or more users. The ranking of users may indicate a defined number of top scores.

The user may use the service through a web interface of the system. The system then may obtain the ranking of users upon use of the service by the user. The system then may record the entry (e.g., in a distributed data structure) using the cryptographic key management application, in which a total value associated to one or more entities via the entry can sum to the minimum value associated with the service. The system may utilize the entry to associate one or more values to the system and/or one or more entities associated with the system. The system may utilize the entry to associate one or more values to an entity associated with the service (e.g., a developer or service provider of the service). The system may utilize the entry to associate one or more values to one or more users based on the ranking of the users. A rank of a user may determine a value to be associated to the user. For example, a user that is ranked in a first position can be associated with a value that is a particular percentage of the minimum value, a user that is ranked in a second position can be associated with another value that is another particular percentage of the minimum value, and so on. Further information regarding entries can be found in the description of FIG. 2.

In at least one embodiment, a system performing at least a part of process 400 includes executable code to process 406 the ranking of users for the service upon completion of use of the service by the user. The system may determine that the user has completed use of the service. In some examples, the user has completed use of the service when the service calculates the score for the user. The system may process the ranking of users based on the score calculated by the service for the user. The system can obtain the score from the service and process the ranking of users based on whether the score is greater than a minimum score of one or more scores for one or more users in the ranking of users; if the score is greater than the minimum score of the one or more scores, the system can update the ranking of users to indicate the user and the score, or if the score is less than and/or equal to the minimum score of the one or more scores, the system can leave the ranking of users as is.

In at least one embodiment, a system performing at least a part of process 400 includes executable code to broadcast 408 another entry encoding at least the ranking of users for the service. The other entry can associate one or more values to the system, and/or any suitable entity. The other entry may encode the ranking of users processed by the system after completion of use of the service by the user.

FIG. 5 is an illustrative, simplified block diagram of a computing device 500 that can be used to practice at least one embodiment of the present disclosure. In various embodiments, the computing device 500 may be used to implement any of the systems illustrated and described above, such as those described in connection with FIGS. 1-4. For example, the computing device 500 may be configured for use as a data server, a web server, a portable computing device, a personal computer, or any electronic computing device. As shown in FIG. 5, the computing device 500 may include one or more processors 502 that, in embodiments, communicate with and are operatively coupled to a number of peripheral subsystems via a bus subsystem. In some embodiments, these peripheral subsystems include a storage subsystem 506, comprising a memory subsystem 508 and a file/disk storage subsystem 510, one or more user interface input devices 512, one or more user interface output devices 514, and a network interface subsystem 516. Such storage subsystem 506 may be used for temporary or long-term storage of information.

In some embodiments, the bus subsystem 504 may provide a mechanism for enabling the various components and subsystems of computing device 500 to communicate with each other as intended. Although the bus subsystem 504 is shown schematically as a single bus, alternative embodiments of the bus subsystem utilize multiple buses. The network interface subsystem 516 may provide an interface to other computing devices and networks. The network interface subsystem 516 may serve as an interface for receiving data from and transmitting data to other systems from the computing device 500. In some embodiments, the bus subsystem 504 is utilized for communicating data such as details, search terms, and so on.

In some embodiments, the user interface input devices 512 includes one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 500. In some embodiments, the one or more user interface output devices 514 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 500. The one or more user interface output devices 514 can be used, for example, to present user interfaces to facilitate user interaction with applications performing processes described and variations therein, when such interaction may be appropriate.

In some embodiments, the storage subsystem 506 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 506. These application modules or instructions can be executed by the one or more processors 502. In various embodiments, the storage subsystem 506 additionally provides a repository for storing data used in accordance with the present disclosure. In some embodiments, the storage subsystem 506 comprises a memory subsystem 508 and a file/disk storage subsystem 510.

In embodiments, the memory subsystem 508 includes a number of memories, such as a main random access memory (RAM) 518 for storage of instructions and data during program execution and/or a read only memory (ROM) 520, in which fixed instructions can be stored. In some embodiments, the file/disk storage subsystem 510 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 500 includes at least one local clock 522. The at least one local clock 522, in some embodiments, is a counter that represents the number of ticks that have transpired from a particular starting date and, in some embodiments, is located integrally within the computing device 500. In various embodiments, the at least one local clock 522 is used to synchronize data transfers in the processors for the computing device 500 and the subsystems included therein at specific clock pulses and can be used to coordinate synchronous operations between the computing device 500 and other systems in a data center. In another embodiment, the local clock is a programmable interval timer.

The computing device 500 could be of any of a variety of types, including a portable computer device, tablet computer, a workstation, or any other device described below. Additionally, the computing device 500 can include another device that, in some embodiments, can be connected to the computing device 500 through one or more ports (e.g., USB, a headphone jack, Lightning connector, etc.). In embodiments, such a device includes a port that accepts a fiber-optic connector. Accordingly, in some embodiments, this device is that converts optical signals to electrical signals that are transmitted through the port connecting the device to the computing device 500 for processing. Due to the ever-changing nature of computers and networks, the description of the computing device 500 depicted in FIG. 5 is intended only as a specific example for purposes of illustrating the preferred embodiment of the device. Many other configurations having more or fewer components than the system depicted in FIG. 5 are possible.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. Further, unless stated otherwise or otherwise clear from context, the phrase “based on” means “based at least in part on” and not “based solely on.”

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more applications) executing collectively on one or more processors, by hardware or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

What is claimed is:

1. A computer-implemented method, comprising:
obtaining a cryptographic key management application associated with a user;
detecting use of a service by the user;
associating one or more values to one or more users based, at least in part, on a ranking of users associated with the service;
processing the ranking of users based, at least in part, on the use of the service by the user; and
broadcasting an entry based, at least in part, on completed use of the service by the user.

2. The computer-implemented method of claim 1, wherein the cryptographic key management application is associated with one or more blockchain addresses.

3. The computer-implemented method of claim 1, further comprising associating the one or more values to the one or more users on behalf of the user using the cryptographic key management application.

4. The computer-implemented method of claim 1, wherein the entry is associated with an encoding of the ranking of users.

5. A system, comprising one or more non-transitory machine-readable media having stored thereon a set of instructions, which if performed by one or more processors, cause the system to at least:
obtain a cryptographic key management application;
broadcast first data indicating at least one or more values based, at least in part, on use of a service by a user;
update a ranking of entities based, at least in part, on the use of the service by the user; and
broadcast second data encoding at least the updated ranking of entities.

6. The system of claim 5, wherein the set of instructions further include instructions, which if performed by the one or more processors, cause the system to at least broadcast the first data and the second data to one or more nodes of a blockchain network.

7. The system of claim 5, wherein the cryptographic key management application encodes one or more cryptographic keys.

8. The system of claim 5, wherein the first data indicates at least associations of the one or more values to one or more entities.

9. The system of claim 8, wherein the one or more entities are indicated by the ranking of entities.

10. The system of claim 5, wherein the set of instructions further include instructions, which if performed by the one or more processors, cause the system to at least:
calculate a value corresponding to the user based on the use of the service by the user; and
update the ranking of entities based, at least in part, on the value.

11. The system of claim 5, wherein the set of instructions further include instructions, which if performed by the one or more processors, cause the system to at least issue one or more non-fungible tokens (NFTs) corresponding to at least one or more users of the service.

12. The system of claim 5, wherein the service is an interactive software application.

13. A non-transitory computer-readable storage medium having stored thereon executable instructions that, as a result of being executed by one or more processors of a computer system, cause the computer system to at least:
detect use of a service by an entity;
associate a first set of values using a cryptographic management application based, at least in part, on a ranking of entities associated with the service;
process the ranking of entities based, at least in part, on the use of the service by the entity; and
associate a second set of values in connection with the processed ranking of entities.

14. The non-transitory computer-readable storage medium of claim 13, wherein the executable instructions further include instructions that, as a result of being executed by the one or more processors of the computer system, cause the computer system to at least associate the first set of values and the second set of values by at least broadcasting respective data to a distributed data structure.

15. The non-transitory computer-readable storage medium of claim 13, wherein the executable instructions further include instructions that, as a result of being executed by the one or more processors of the computer system, cause the computer system to at least provide one or more tokens to one or more users based, at least in part, on one or more amounts of values associated in connection with the one or more users in a time interval.

16. The non-transitory computer-readable storage medium of claim 13, wherein the executable instructions further include instructions that, as a result of being executed by the one or more processors of the computer system, cause the computer system to at least associate a first value of the first set of values to a first entity of the ranking of entities.

17. The non-transitory computer-readable storage medium of claim 16, wherein the first entity is in a first position of the ranking of entities.

18. The non-transitory computer-readable storage medium of claim 13, wherein the first set of values corresponds to a minimum value associated with the service.

19. The non-transitory computer-readable storage medium of claim 13, wherein the executable instructions further include instructions that, as a result of being executed by the one or more processors of the computer system, cause the computer system to at least:
calculate a value based on the use of the service by the entity; and
determine whether the value is greater than one or more values indicated by the ranking of entities.

20. The non-transitory computer-readable storage medium of claim 19, wherein the executable instructions further include instructions that, as a result of being executed by the one or more processors of the computer system, cause the computer system to at least, as a result of determining that the value is greater than a minimum value of the one or more values, process the ranking of entities by at least updating the ranking of entities to include the value.
